(19) United States
(12) Patent Application Publication
(10) Pub. No.: US 2026/0308409 A1
(43) Pub. Date: Oct. 8, 2026

(54) COMPOUND, COATING COMPOSITION AND FILM

(71) Applicant: INDUSTRIAL TECHNOLOGY RESEARCH INSTITUTE, Hsinchu (TW)

(72) Inventors: Shuang-Huei CHEN, Zhubei City (TW); Ming-Tzung WU, Hsinchu City (TW); Yao-Jheng HUANG, Taipei City (TW); Yu-Chin LIN, Zhudong Township (TW); Te-Yi CHANG, Taoyuan City (TW)

(73) Assignee: INDUSTRIAL TECHNOLOGY RESEARCH INSTITUTE, Hsinchu (TW)

(21) Appl. No.: 19/434,524

(22) Filed: Dec. 29, 2025

Related U.S. Application Data
(60) Provisional application No. 63/777,847, filed on Mar. 26, 2025.

(30) Foreign Application Priority Data
Dec. 19, 2025 (TW) 114150191

(51) Int. Cl. C09D 151/08; C08F 290/06; C08G 65/332; C08G 65/333; C09D 4/06; C09D 5/32; C09D 7/20; G02B 5/20

(52) U.S. Cl. CPC C09D 151/08; C08F 290/062; C08G 65/3322; C08G 65/33351; C08G 65/33355; C09D 4/06; C09D 5/32; C09D 7/20; G02B 5/208

(57) ABSTRACT

A compound, a coating composition and a film are provided. The compound has a structure represented by Formula (I)

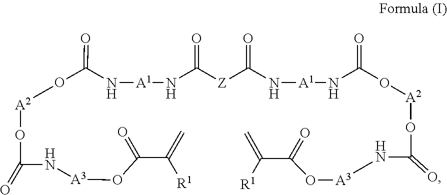

wherein Z, A¹, A², A³, and R¹ are disclosed in the specification. The coating composition includes 100 parts by weight of component (A) and 1 to 200 parts by weight of component (B), wherein component (A) is the above compound.

### CROSS REFERENCE TO RELATED APPLICATIONS

This application claims priority of Taiwan Patent Application No. 114150191, filed on Dec. 19, 2025, the entirety of which is incorporated by reference herein. This application also claims the benefit of U.S. Provisional Application No. 63/777,847, filed on Mar. 26, 2025, which is hereby incorporated by reference herein in its entirety.

### TECHNICAL FIELD

The disclosure relates to a compound, a coating composition employing the same, and a film.

### BACKGROUND

In micro light-emitting diode (Micro-LED) display technology, a substrate is typically coated with a black matrix (BM) to prevent optical crosstalk between pixels and to enhance display contrast. However, during a process in which light-emitting units are connected to contact pads using a laser process, most carbon-black-based photoresists currently in use strongly absorb laser or infrared (IR) radiation, causing the photoresist to undergo excessive and instantaneous heat accumulation and resulting in ablation or burning of the ink layer. This not only degrades the integrity of the light-shielding layer, but it may also cause thermal damage to the substrate and the electronic components, thereby adversely affecting the manufacturing yield.

In addition, although conventional black photoresist materials can satisfy light-shielding requirements, they typically exhibit hard and brittle characteristics after curing and are not resistant to repeated bending. Furthermore, due to insufficient infrared transmittance, such materials may cause alignment errors during processing. As a result, conventional black photoresist materials are generally limited to rigid-substrate packaging and are difficult to apply to flexible or bendable substrates, thereby failing to meet the requirements of roll-to-roll Micro-LED display technologies.

Accordingly, there is a need in the art to develop novel light-shielding materials capable of overcoming the aforementioned problems.

### SUMMARY

According to embodiments of the disclosure, the disclosure provides a compound having a structure of Formula (I)

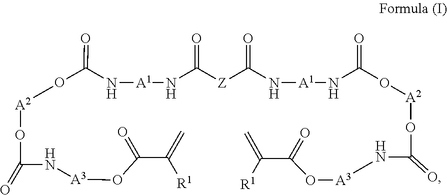

wherein Z may be

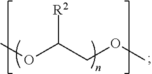

A¹ may be independently C3-C12 alkylene group,

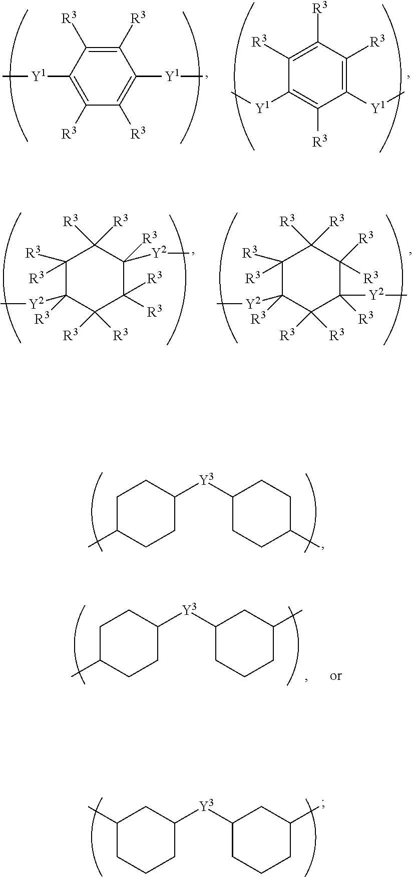

A² may be independently C2-C12 alkylene group having at least one carboxyl group; A³ may be independently C1-C12 alkylene group, C2-C12 divalent ether group, C4-C8 cycloalkylene group, phenylene group, or

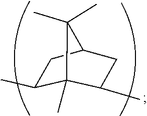

R¹ and R² may be independently hydrogen or methyl; n may be an integer from 6 to 100; R³ may be independently hydrogen, or C1-C6 alkyl group Y¹ may be independently C1-C6 alkylene group; Y² may be independently a single bond, or C1-C6 alkylene group; Y³ may be —O—,

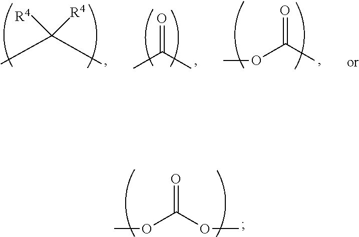

and, R⁴ may be independently hydrogen, fluorine, methyl, or fluoromethyl.

According to embodiments of the disclosure, the disclosure provides a coating composition. The coating composition includes 100 parts by weight of component (A), and 1 to 200 parts by weight of component (B). According to embodiments of the disclosure, component (A) is the compound of the disclosure having a structure of Formula (I). According to embodiments of the disclosure, component (B) may be a compound having at least two reactive functional groups, and the reactive functional group is acrylate group, or methacrylate group.

According to embodiments of the disclosure, the disclosure also provides a film, wherein the film includes the cured product of the coating composition of the disclosure.

A detailed description is given in the following embodiments.

### DETAILED DESCRIPTION

The compound, coating composition, and film of the disclosure are described in detail in the following description. In the following detailed description, for purposes of explanation, numerous specific details and embodiments are set forth in order to provide a thorough understanding of the present disclosure. The specific elements and compositions described in the following detailed description are set forth in order to clearly describe the present disclosure. It will be appeared

Furthermore, the use of ordinal terms such as “first”, “second”, “third”, etc., in the disclosure to modify an element does not by itself connote any priority, precedence, order of one claim element over another or the temporal order in which it is formed, but are used merely as labels to distinguish one claim element having a certain name from another element having the same name (but for use of the ordinal term) to distinguish the claim elements.

The disclosure provides a compound. The compound is a urethane compound having carboxyl groups and reactive functional groups, such as acrylate groups or methacrylate groups. A composition including the compound of the disclosure, after curing, can exhibit high adhesion and infrared light transmittance, and may be readily formed into a patterned film having high resolution.

The disclosure also provides a coating composition capable of forming a flexible film, such as a transparent film or an infrared-transmissive film, which is particularly suitable for application to flexible or bendable devices, such as organic light-emitting diode (OLED) devices, mini/micro light-emitting diode (Mini/Micro-LED) devices, or semiconductor devices. In addition to facilitating infrared-based alignment during processing, the coating composition and the thus-formed film can avoid heat accumulation, thereby maintaining the optical performance of the device and extending the lifetime of the device. Furthermore, when the coating composition of the disclosure further includes a pigment and a dispersant, it may be used to form an infrared-transmissive light-shielding layer, which further suppresses ambient light reflection and enhances contrast.

According to embodiments of the disclosure, the disclosure provides a compound having a structure of Formula (I)

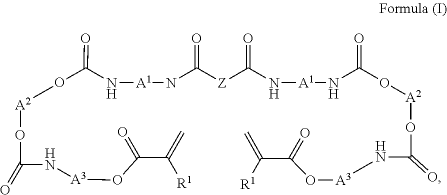

wherein Z may be

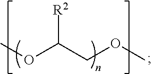

A¹ may be independently C3-C12 alkylene group,

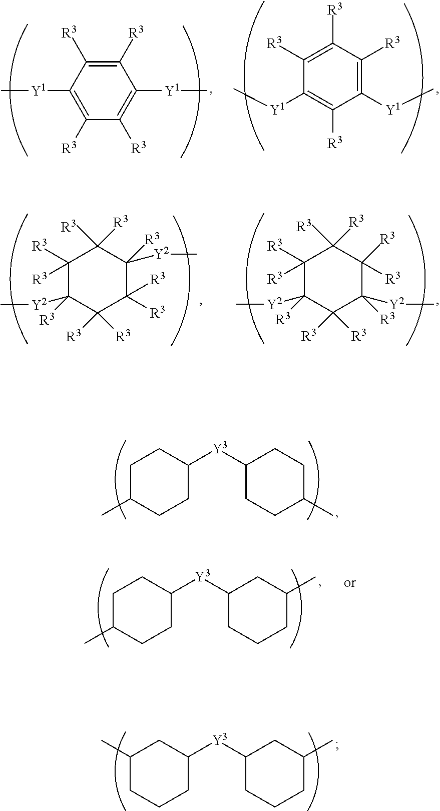

A² may be independently C2-C12 alkylene group having at least one carboxyl group; A³ may be independently C1-C12 alkylene group, C2-C12 divalent ether group, C4-C8 cycloalkylene group, phenylene group, or

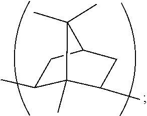

R¹ and R² may be independently hydrogen or methyl; n may be an integer from 6 to 100 (such as 7, 8, 9, 10, 15, 20, 25, 30, 35, 40, 45, 50, 55, 60, 65, 70, 75, 80, 85, 90, or 95); R³ may be independently hydrogen, or C1-C6 alkyl group Y¹ may be independently C1-C6 alkylene group; Y² may be independently a single bond, or C1-C6 alkylene group; Y³ may be —O—,

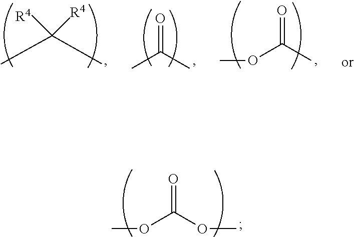

and, R⁴ may be independently hydrogen, fluorine, methyl, or fluoromethyl.

According to embodiments of the disclosure, each A¹ may be the same or different; each A² may be the same or different; each A³ may be the same or different; and, each R¹ may be the same or different.

According to embodiments of the disclosure, the alkyl group of the disclosure may be a linear or branched alkyl group. For example, C1-C6 alkyl group may be methyl, ethyl, propyl, butyl, pentyl, hexyl, or an isomer thereof.

According to embodiments of the disclosure, the alkylene group of the disclosure may be a linear or branched alkylene group. For example, C1-C12 alkylene group may be methylene, ethylene, propylene, butylene, pentylene, hexylene, heptylene, octylene, nonylene, decylene, undecylene, dodecylene, or an isomer thereof.

According to embodiments of the disclosure, the divalent ether group refers to an alkylene group having at least one in-chain ether oxygen atom, that is, a divalent ether group refers to an alkylene group in which at least one non-terminal —CH₂— unit is replaced by an —O— group. For example, C2-C12 divalent ether group may be

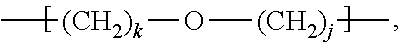

wherein j and k are independently an integer from 1 to 11 (such as 2, 3, 4, 5, 6, 7, 8, 9, or 10), and a sum of j and k may be 2 to 12 (such as 3, 4, 5, 6, 7, 8, 9, 10 or 11).

According to embodiments of the disclosure, the cycloalkylene group of the disclosure refers to a divalent cycloalkyl group, and the two groups bonded to the cycloalkylene group may be attached to the same atom or to different atoms of the cycloalkylene group. For example, a C4-C8 cycloalkylene group may be cyclobutylene, cyclopentylene, cyclohexylene, cycloheptylene, or cyclooctylene.

According to embodiments of the disclosure, the fluoromethyl group refers to a methyl group in which one or more hydrogen atoms bonded to carbon atom are optionally replaced with fluorine atoms. For example, a fluoromethyl group may be monofluoromethyl, difluoromethyl, or perfluoromethyl.

According to embodiments of the disclosure, a compound having a structure represented by Formula (I) may have an acid value of about 20 mgKOH/g to 100 mgKOH/g (such as 25 mgKOH/g, 30 mgKOH/g, 35 mgKOH/g, 40 mgKOH/g, 45 mgKOH/g, 50 mgKOH/g, 55 mgKOH/g, 60 mgKOH/g, 65 mgKOH/g, 70 mgKOH/g, 75 mgKOH/g, 80 mgKOH/g, 85 mgKOH/g, 90 mgKOH/g, or 95 mgKOH/g), wherein the acid value of the compound is measured in accordance with the method specified in ASTM D1045.

According to embodiments of the disclosure, in the compound having a structure of Formula (I), Z is derived from polyethylene glycol (PEG) or polypropylene glycol (PPG), that is, Z is a dehydrogenated residue of polyethylene glycol (PEG) or polypropylene glycol (PPG).

According to embodiments of the disclosure, A¹ may be independently

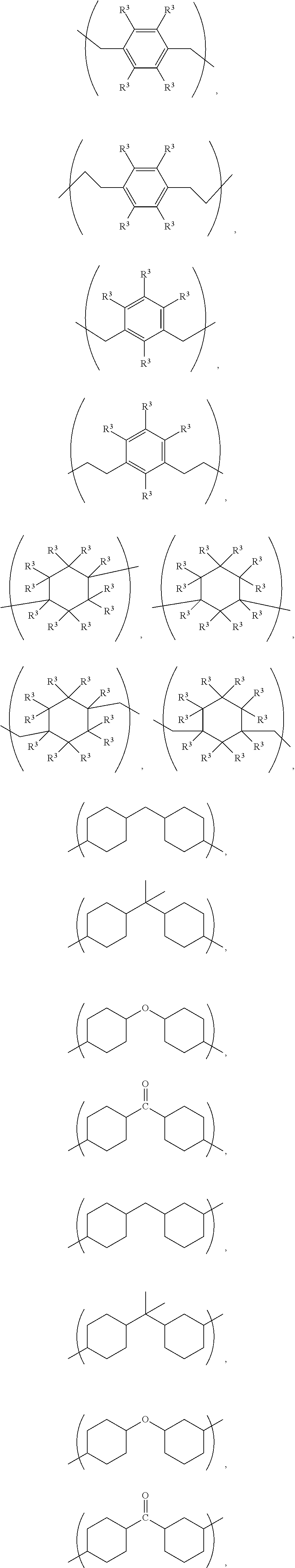

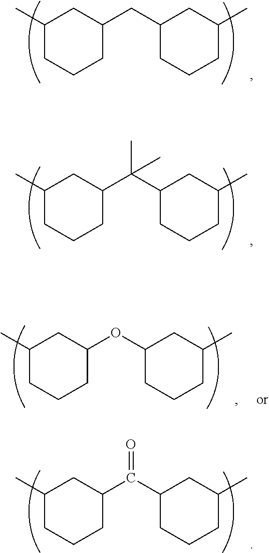

According to embodiments of the disclosure, the compound having a structure of Formula (I) may be

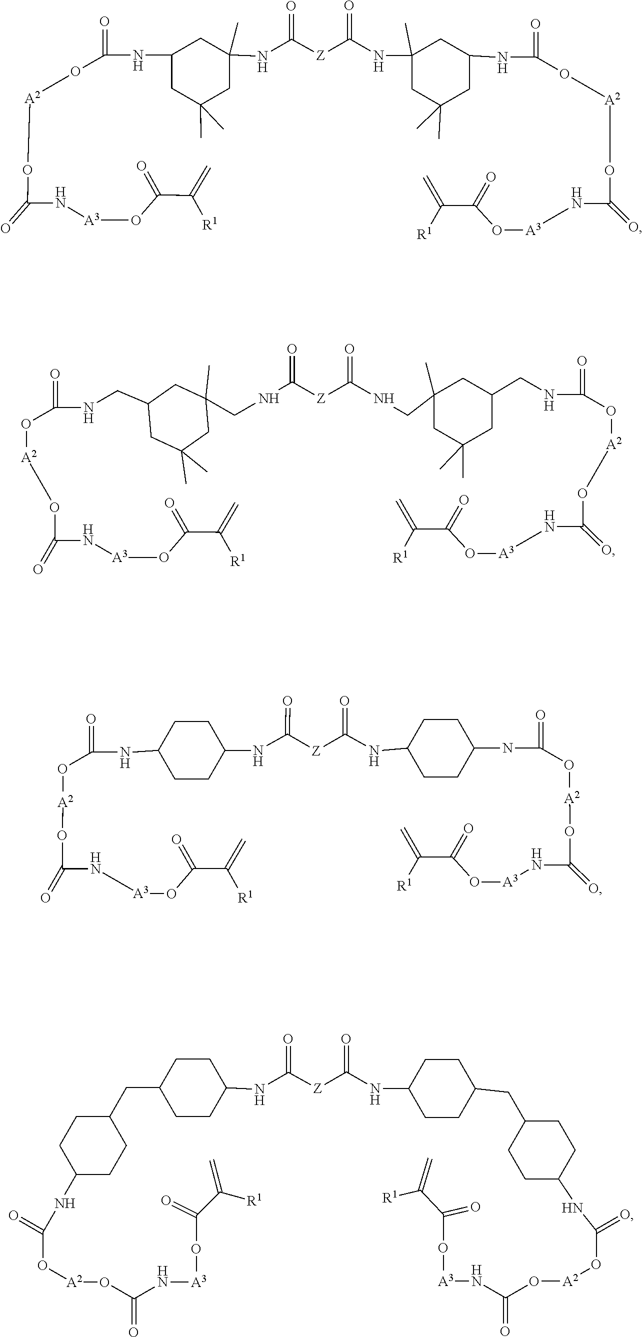

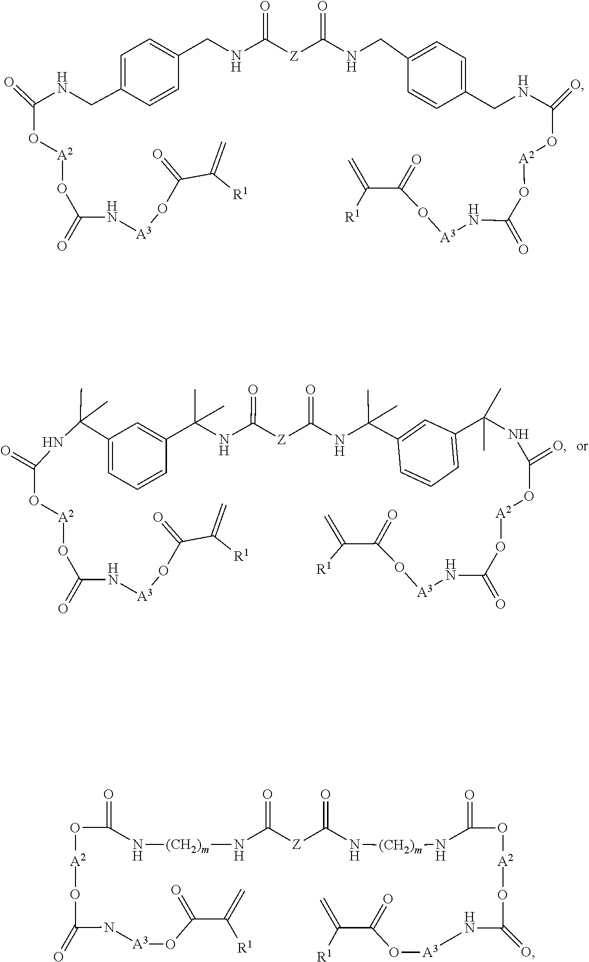

wherein Z, A², A³, and R¹ are the same as defined above, m may be independently an integer from 3 to 12 (such as 4, 5, 6, 7, 8, 9, 10, or 11).

According to embodiments of the disclosure, the compound having a structure of Formula (I) may be

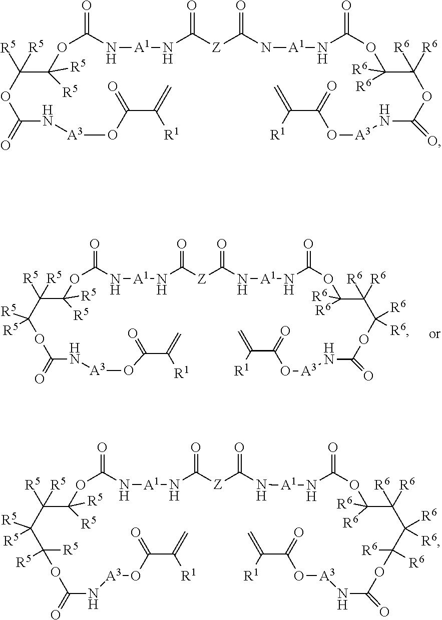

wherein Z, A¹, A³, and R¹ are the same as defined above; R⁵ may be independently hydrogen, C1-C3 alkyl group, or —COOH, and wherein at least one of R⁵ is —COOH; and, R⁶ may be independently hydrogen, C1-C3 alkyl group, or —COOH, and wherein at least one of R⁶ is —COOH.

According to embodiments of the disclosure, the compound having a structure of Formula (I) may be

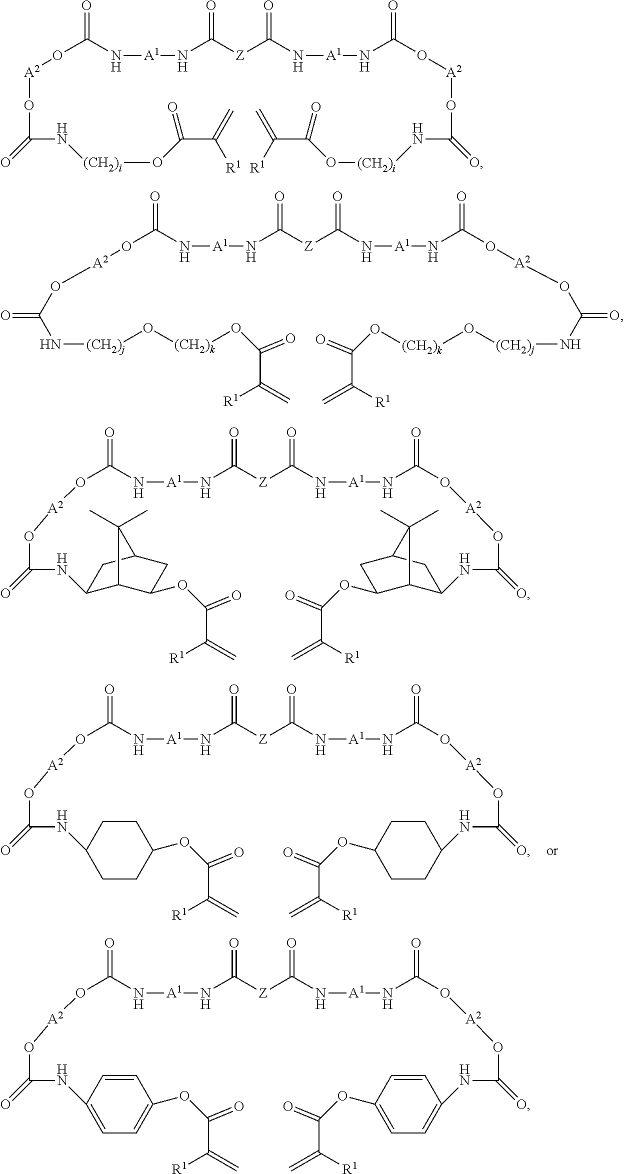

wherein Z, A¹, A², and R¹ are the same as defined above; i may be an integer from 1 to 12 (such as 2, 3, 4, 5, 6, 7, 8, 9, 10 or 11); and j and k may be independently an integer from 1 to 11 (such as 2, 3, 4, 5, 6, 7, 8, 9, or 10), a sum of j and k may be 2 to 12 (such as 3, 4, 5, 6, 7, 8, 9, 10 or 11).

According to embodiments of the disclosure, the preparation method of the compound of the disclosure may include the following steps. First, a reactant (A) is subjected to a urethane esterification reaction with a reactant (B) to obtain a reactant (C). Next, the reactant (C) is subjected to a urethane esterification reaction with a reactant (D) to obtain a reactant (E). Finally, the reactant (E) is subjected to a urethane esterification reaction with a reactant (F) to obtain the compound of the disclosure.

According to embodiments of the disclosure, the urethane esterification reaction may be carried out at a temperature of 30 to 100° C., and the reaction time may be about 30 minutes to 10 hours. According to embodiments of the disclosure, prior to performing the urethane esterification reaction, the reactants may be dissolved in a solvent. According to embodiments of the disclosure, the urethane esterification reaction may be carried out in the presence of a catalyst, wherein the catalyst may be any conventional catalyst used for urethane esterification reactions. For example, the catalyst may be an organometallic catalyst, such as dibutyltin dilaurate (DBTDL), stannous octoate, dibutyltin diacetate, dioctyltin diacetate, dibutyltin maleate, dibutyltin di-2-ethylhexanoate, or dibutyltin dimercaptide.

According to embodiments of the disclosure, reactant (A) may be polyethylene glycol (PEG) or polypropylene glycol (PPG), and the polyethylene glycol (PEG) or polypropylene glycol may have a weight average molecular weight (Mw) of about 400 g/mol to 4,000 g/mol. According to embodiments of the disclosure, reactant (A) may be

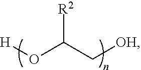

wherein R² is independently hydrogen or methyl; and, n is an integer from 6 to 100. According to embodiments of the disclosure, the reactant (B) may be a compound having two isocyanate groups. According to embodiments of the disclosure, the reactant (B) may be

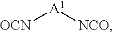

wherein A¹ may be C3-C12 alkylene group,

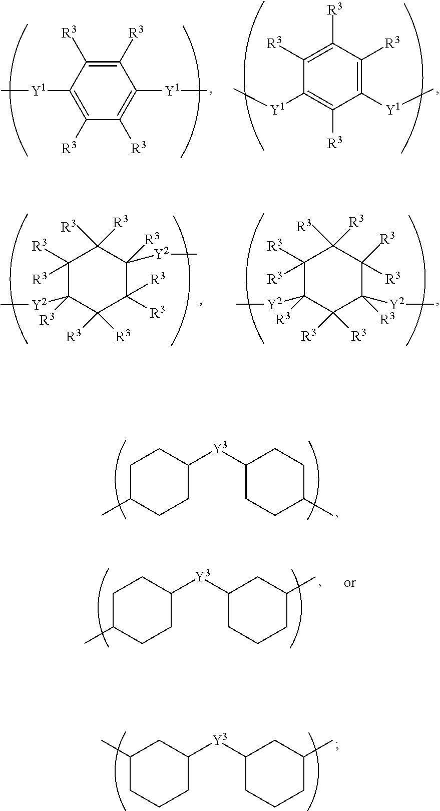

R³ may be independently hydrogen, or C1-C6 alkyl group; Y may be independently C1-C6 alkylene group; Y² may be a single bond, or C1-C6 alkylene group; Y³ may be —O—,

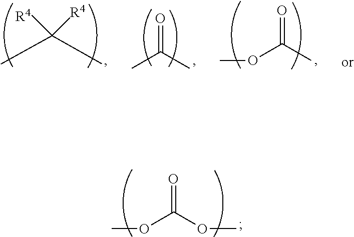

and, R⁴ may be independently hydrogen, fluorine, methyl, or fluoromethyl. According to embodiments of the disclosure, the reactant (C) may be

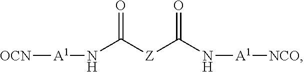

wherein Z is

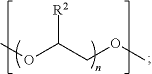

A¹ may be C3-C12 alkylene group,

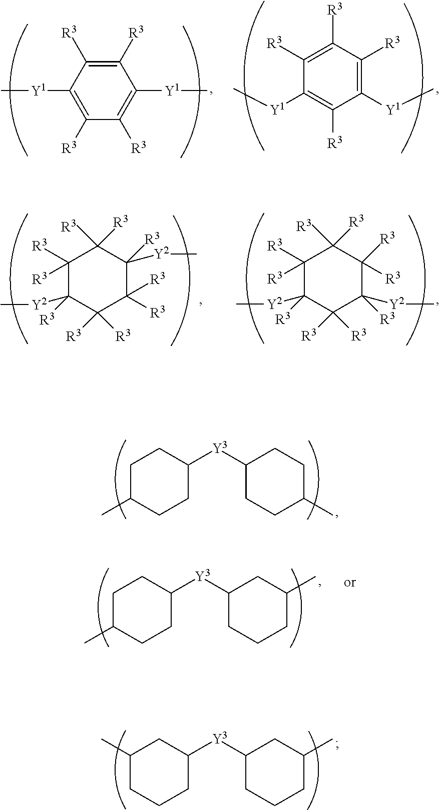

R² may be hydrogen or methyl; R³ may be independently hydrogen, or C1-C6 alkyl group; Y¹ may be independently C1-C6 alkylene group; Y² may be independently a single bond, or C1-C6 alkylene group; Y³ may be —O—,

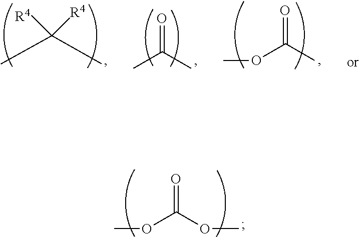

R⁴ may be independently hydrogen, fluorine, methyl or fluoromethyl; and, n is an integer from 6 to 100. According to embodiments of the disclosure, in order to ensure that the terminal hydroxyl groups of reactant (A) are completely consumed to form urethane groups, the molar ratio of reactant (A) to reactant (B) may be about 1:2 to 1:2.5.

According to embodiments of the disclosure, reactant (D) may be an aliphatic diol compound having at least one carboxyl group. According to embodiments of the disclosure, the reactant (D) may be

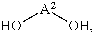

wherein A² is independently C2-C12 alkylene group having at least one carboxyl group. According to embodiments of the disclosure, the reactant (E) may be

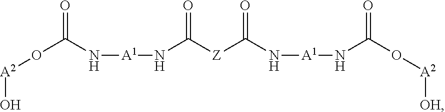

### Z is

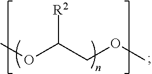

A¹ may be C3-C12 alkylene group,

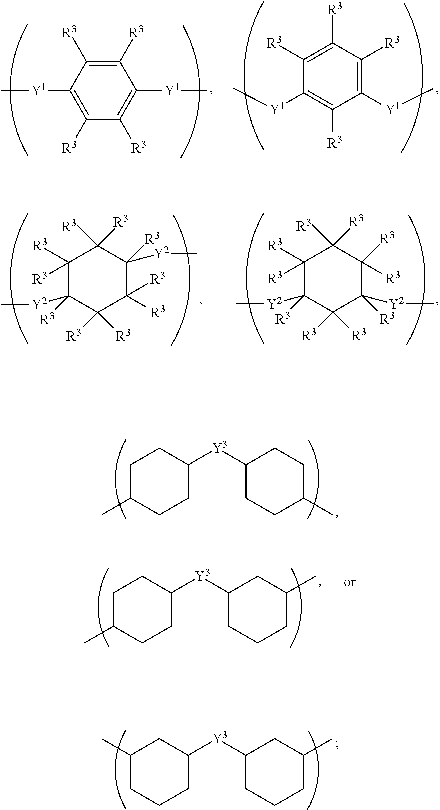

A² may be independently C2-C12 alkylene group having at least one carboxyl group; R² may be hydrogen or methyl; R³ may be independently hydrogen, or C1-C6 alkyl group; Y¹ may be independently C1-C6 alkylene group; Y² may be independently a single bond, or C1-C6 alkylene group; Y³ may be —O—,

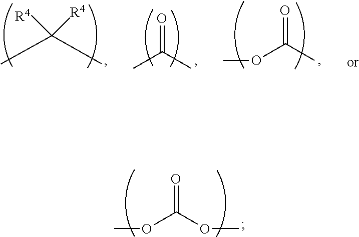

R⁴ may be independently hydrogen, fluorine, methyl, or fluoromethyl; and, n is an integer from 6 to 100. According to embodiments of the disclosure, in order to ensure that the terminal isocyanate groups of reactant (C) are completely consumed to form urethane groups, the molar ratio of reactant (C) to reactant (D) may be about 1:2 to 1:2.5.

According to embodiments of the disclosure, reactant (F) may be an acrylate compound having one isocyanate group. According to embodiments of the disclosure, reactant (F) may be

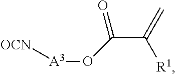

wherein A³ may be C1-C12 alkylene group, C2-C12 divalent ether group, C4-C8 cycloalkylene group, phenylene, or

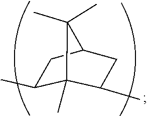

and, R¹ may be hydrogen or methyl. According to embodiments of the disclosure, in order to ensure that the terminal hydroxyl groups of reactant (E) are completely consumed to form urethane groups, the molar ratio of reactant (E) to reactant (F) may be about 1:2 to 1:2.5.

According to embodiments of the disclosure, the synthesis pathway for preparing the compound is as follows:

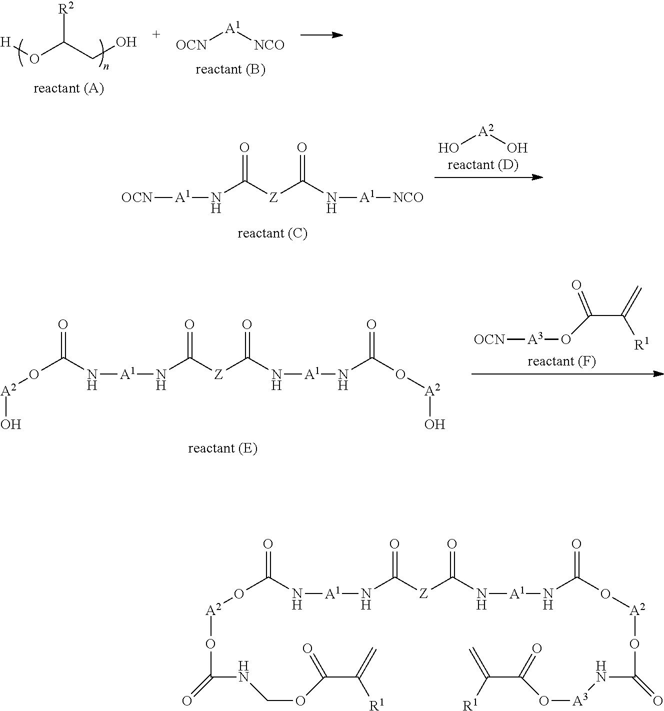

According to embodiments of the disclosure, the disclosure also provides a coating composition. The coating composition can include 100 parts by weight of component (A), and 1 to 200 parts by weight of component (B) (such as 2 parts by weight, 5 parts by weight, 10 parts by weight, 20 parts by weight, 30 parts by weight, 50 parts by weight, 120 parts by weight, 150 parts by weight, or 180 parts by weight). According to embodiments of the disclosure, component (A) is the compound of the disclosure having a structure of Formula (I). According to embodiments of the disclosure, component (B) is a compound having at least two reactive functional groups, and the reactive functional group is acrylate group, or methacrylate group.

According to embodiments of the disclosure, a compound having at least two reactive functional groups may be a compound having two acrylate groups, a compound having two methacrylate groups, a compound having three acrylate groups, a compound having three methacrylate groups, a compound having four acrylate groups, a compound having four methacrylate groups, a compound having five acrylate groups, a compound having five methacrylate groups, a compound having six acrylate groups, a compound having six methacrylate groups, or a combination thereof.

According to embodiments of the disclosure, component (B) may be 1,6-hexanediol diacrylate (HDDA), 1,6-hexanediol dimethacrylate, 1,9-bis(acryloyloxy)nonane, 1,9-bis(methacryloyloxy)nonane, 1,10-decanediol diacrylate (DDDA), 1,10-decanediol dimethacrylate, neopentyl glycol diacrylate, neopentyl glycol dimethacrylate, polyethylene glycol (PEG) (200) diacrylate (PEG200DA), polyethylene glycol (400) diacrylate (PEG400DA), polyethylene glycol (600) diacrylate (PEG600DA), dipropylene glycol diacrylate (DPGDA), dipropylene glycol dimethacrylate, tripropylene glycol diacrylate (TPGDA), tripropylene glycol dimethacrylate, di(ethylene glycol) diacrylate, di(ethylene glycol) dimethacrylate, triethylene glycol diacrylate (TIEGDA), triethylene glycol dimethacrylate, tetraethylene glycol diacrylate (TTEGDA), tetraethylene glycol dimethacrylate, dipentaerythritol hexaacrylate (DPHA), dipentaerythritol hexamethacrylate, dipentaerythritol pentaacrylate (DPPA), dipentaerythritol pentamethacrylate, polypropylene glycol diacrylate, poly(tetramethylene ether glycol) diacrylate, poly(ethylene-propylene glycol) diacrylate, tricyclodecanedimethanol diacrylate (TCDDMDA), trimethylolpropane triacrylate (TMPTA), pentaerythritol triacrylate (PETIA), pentaerythritol tetraacrylate (PETTA), di(trimethylolpropane) tetraacrylate (Di-TMPTTA), di(polypentaerythritol) polyacrylate, polypentaerythritol polyacrylate, polybutadiene diacrylate (PBDDA), 3-methyl-1,5-pentanediol diacrylate (MPDA), ethoxylated (3) bisphenol A diacrylate (BPA3EODA), tris(2-hydroxyethyl)isocyanurate triacrylate (THEICTA), ethoxylated (20) trimethylolpropane triacrylate (TMP20EOTA), ethoxylated (3) trimethylolpropane triacrylate (TMP3EOTA), propoxylated (3) trimethylolpropane triacrylate (TMP3POTA), ethoxylated pentaerythritol tetraacrylate, ethoxylated (6) trimethylolpropane triacrylate (TMP6EOTA), ethoxylated (9) trimethylolpropane triacrylate (TMP9EOTA), ethoxylated (4) bisphenol A diacrylate (BPA4EODA), ethoxylated (10) bisphenol A diacrylate (BPA10EODA), esterdiol diacrylate (EDDA), alkoxylated diacrylate, propoxylated (2) neopentyl glycol diacrylate (PONPGDA), propoxylated (3) glyceryl triacrylate (GPTA), ethoxylated (15) trimethylolpropane triacrylate (TMP15EOTA), ethoxylated (12) glyceryl triacrylate (G12EOTA), 2-(dimethylamino)ethyl acrylate, 3-(dimethylamino)propyl acrylate, 2-(diethylamino)ethyl acrylate, 3-(diethylamino)propyl acrylate, 2-(dimethylamino)ethyl methacrylate, 3-(dimethylamino)propyl methacrylate, 2-(diethylamino)ethyl methacrylate, 3-(diethylamino)propyl methacrylate, urethane multi-acrylate, urethane multi-methacrylate, or a combination thereof.

According to embodiments of the disclosure, the urethane multi-acrylate may be an aromatic urethane multi-acrylate, an aliphatic urethane multi-acrylate, or a combination thereof. According to embodiments of the disclosure, the urethane multi-methacrylate may be an aromatic urethane multi-methacrylate, an aliphatic urethane multi-methacrylate, or a combination thereof.

According to embodiments of the disclosure, since component (A) used in the coating composition includes a compound having multiple intramolecular urethane groups, when component (B) is a urethane multi-(meth)acrylate, the compatibility between components (A) and (B) in the coating composition can be improved, thereby further enhancing the flexibility of the cured product and its adhesion to a substrate, so as to meet the requirements of flexible and bendable devices.

According to embodiments of the disclosure, in order to accelerate the reactivity between component (A) and component (B) during a curing process, the coating composition may further include an initiator as component (C). According to embodiments of the disclosure, the weight ratio of component (C) to the total weight of component (A) and component (B) may be from 1:20 to 1:2, for example 1:19, 1:18, 1:17, 1:16, 1:15, 1:14, 1:13, 1:12, 1:11, 1:10, 1:9, 1:8, 1:7, 1:6, 1:5, 1:4, 1:3, or 3:7.

According to embodiments of the disclosure, the initiator of the disclosure may be a photoinitiator. According to embodiments of the disclosure, the main absorption wavelength of the photoinitiator may be from about 300 nm to 450 nm. According to embodiments of the disclosure, the main absorption wavelength of the photoinitiator may also be less than about 300 nm, so as to meet the UV exposure requirements of currently commercial i-line and h-line processes.

According to embodiments of the disclosure, the selection of the photoinitiator is not particularly limited and may be optionally modified by a person having ordinary skill in the art. The photoinitiator may be a photoinitiator conventionally used in coating compositions. For example, the photoinitiator may be a benzoin-based compound, an acetophenone-based compound, a thioxanthone-based compound, a ketal compound, a benzophenone-based compound, an α-aminoacetophenone compound, an acylphosphine oxide compound, a biimidazole-based compound, a triazine-based compound, or a combination thereof.

According to embodiments of the disclosure, the acetophenone-based compound may be a photoinitiator manufactured by Ciba Geigy and having a trade name of Irgacure 2959, Irgacure 184, Irgacure 500, Irgacure 651, Irgacure 369, Irgacure 379, Irgacure 907, or Darocur 1173. According to embodiments of the disclosure, the acylphosphine oxide compound may be a photoinitiator manufactured by Ciba Geigy and having a trade name of Irgacure 819 or Irgacure 1800, or manufactured by BASF and having a trade name of Lucirin TPO or Lucirin TPO-L. According to embodiments of the disclosure, the initiator of the disclosure may also be a photoinitiator manufactured by Lambson, having a trade name of Esacure 1001M, Esacure KIP150, Speedcure BEM, Speedcure EHA, Speedcure BMS, Speedcure MBP, Speedcure PBZ, Speedcure ITX, Speedcure DETX, Speedcure EBD, Speedcure MBB, or Speedcure BP, or manufactured by Ciba Geigy and having a trade name of Irgacure 2100, Irgacure 250, or Irgacure 784.

According to embodiments of the disclosure, the coating composition may further include a solvent as component (D), for dissolving component (A) and component (B) (or component (A), component (B), and component (C)). Accordingly, all components of the coating composition may be uniformly dissolved or dispersed in the solvent. According to embodiments of the disclosure, the weight ratio of component (D) to the total weight of component (A) and component (B) may be from 1:2 to 5:1, for example 4:6, 1:1, 6:4, or 2:1.

According to embodiments of the disclosure, the solvent may be an aromatic hydrocarbon solvent, an alcohol solvent, an ether solvent, a ketone solvent, an ester solvent, a nitrogen-containing solvent, or a combination thereof. According to embodiments of the disclosure, the solvent may include benzene, toluene, xylene, ethylbenzene, diethylbenzene, trimethylbenzene, triethylbenzene, cyclohexane, cyclohexene, decahydronaphthalene, dipentene, pentane, hexane, heptane, octane, nonane, decane, ethylcyclohexane, methylcyclohexane, p-menthane, dipropyl ether, dibutyl ether, anisole, ethyl acetate, butyl acetate, pentyl acetate, methyl isobutyl ketone, cyclohexylbenzene, cyclohexanone, cyclopentanone (CPN), triglyme, 1,3-dimethyl-2-imidazolidinone (DMI), N-methyl-2-pyrrolidone (NMP), methyl ethyl ketone (MEK), N,N-dimethylacetamide (DMAc), N,N-dimethylpropionamide, γ-butyrolactone (GBL), N,N-dimethylformamide (DMF), propylene glycol methyl ether acetate (PGMEA), dimethyl sulfoxide (DMSO), or a combination thereof.

According to embodiments of the disclosure, when the coating composition includes a solvent, the solid content of the coating composition is not particularly limited and may be adjusted according to application requirements. According to embodiments of the disclosure, the solid content may be from about 10% to 90%, such as about 15%, 20%, 25%, 30%, 35%, 40%, 45%, 50%, 55%, 60%, 65%, 70%, 75%, 80%, or 85%. As used herein, the solid content refers to the percentage of the total weight of all components other than the solvent (the non-volatile parts), based on the total weight of the coating composition.

According to embodiments of the disclosure, the coating composition may include 100 parts by weight of component (A), 1 to 200 parts by weight of component (B), component (C), and component (D), wherein the weight ratio of component (C) to the total weight of component (A) and component (B) may be from 1:20 to 1:2, and the weight ratio of component (D) to the total weight of component (A) and component (B) may be from 1:2 to 5:1.

According to some embodiments of the disclosure, the coating composition may further include a pigment as component (E), for forming a light-shielding layer having infrared light transmittance. According to embodiments of the disclosure, the weight ratio of component (E) to the total weight of component (A) and component (B) may be from 1:100 to 20:100, for example 2:100, 3:100, 4:100, 5:100, 6:100, 7:100, 8:100, 9:100, 10:100, 11:100, 12:100, 13:100, 14:100, 15:100, 16:100, 17:100, 18:100, or 19:100. The pigment may be directly a black pigment, or may be formed by mixing pigments of different colors to obtain black, for example by using an RGB pigment system or a CMY pigment system. The type of pigment used in the coating composition is not particularly limited. For example, the pigment may absorb visible light but not absorb infrared light in a wavelength range of 700 nm to 1500 nm, or may have a low absorption rate in such range (for example, a heat-shielding pigment having an infrared transmittance of 50% or more in the range of 700 nm to 1500 nm, measured in accordance with JIS K 5602). According to embodiments of the disclosure, the pigment may be an inorganic pigment, an organic pigment, or a combination thereof. According to embodiments of the disclosure, the pigment may be an azo pigment, thioindigo pigment, anthraquinone pigment, perylene pigment (such as BASF L0084 or L0086), pyrrole pigment, dioxazine pigment, phthalocyanine pigment, isoindolinone pigment, ceramic pigment, oxide pigment, metal pigment, alloy pigment, mica, nitride pigment, sulfide pigment, carbon black, or a combination thereof.

According to some embodiments of the disclosure, the coating composition may further include a dispersant as component (F), in combination with component (E), to form a light-shielding layer having infrared light transmittance. According to embodiments of the disclosure, the weight ratio of component (F) to the total weight of component (A) and component (B) may be from 1:100 to 20:100, for example 2:100, 3:100, 4:100, 5:100, 6:100, 7:100, 8:100, 9:100, 10:100, 11:100, 12:100, 13:100, 14:100, 15:100, 16:100, 17:100, 18:100, or 19:100. The type of dispersant used in the coating composition is not particularly limited. For example, the dispersant may be a compound having basic functional groups, such as a dispersant having an amine value of from 1 mgKOH/g to 100 mgKOH/g. For example, the dispersant may be Disparlon DA-7301 manufactured by Kusumoto Chemicals, or BYK-161, BYK-162, BYK-163, or BYK-182 manufactured by BYK-Chemie.

According to embodiments of the disclosure, the coating composition may be obtained by uniformly mixing all components. According to embodiments of the disclosure, component (E) and component (F) may be first mixed with component (D) and subjected to a dispersion treatment to obtain a dispersion, and the dispersion may then be mixed with the other components to obtain the coating composition.

According to embodiments of the disclosure, the disclosure further provides a film (such as an infrared-transmittance layer or a light-shielding layer) including a cured product of the coating composition of the disclosure. According to embodiments of the disclosure, the film may be obtained by subjecting the coating composition to a curing process.

According to embodiments of the disclosure, a method for preparing the film may include the following steps. First, the coating composition of the disclosure is provided. Next, a coating of the coating composition is formed on a substrate by a coating process. Next, the coating is subjected to a curing process to obtain a cured product, such as a film. According to embodiments of the disclosure, the curing process may be a ultraviolet irradiation treatment. According to some embodiments of the disclosure, the curing process may include a ultraviolet irradiation treatment and a baking treatment, wherein the baking temperature may be from 30° C. to 200° C. According to embodiments of the disclosure, the substrate is not particularly limited and may be a metal sheet, a silicon substrate, glass, or a polymer film, and any desired layer or element may be formed on the substrate in advance. According to embodiments of the disclosure, the light source of the ultraviolet irradiation treatment may be UV light having a wavelength of from 150 nm to 450 nm, and an irradiation intensity of from 10 mW to 100 mW.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity.

### Compound

### Preparation Example 1

Polypropylene glycol (PPG-400) (14 g) and dibutyltin dilaurate (DBTBL) (0.07 g) were dissolved in propylene glycol methyl ether acetate (PGMEA) (10 g) to obtain a first solution. 2,2-bis(hydroxymethyl)propionic acid (DMPA) (9.39 g) and dibutyltin dilaurate (0.07 g) were dissolved in N,N-dimethylacetamide (DMAc) (18.77 g) to obtain a second solution. Methacryloyloxyethyl isocyanate (MOI) (10.86 g) and dibutyltin dilaurate (0.07 g) were dissolved in propylene glycol methyl ether acetate (PGMEA) (10 g) to obtain a third solution.

Isophorone diisocyanate (IPDI) (15.55 g) and propylene glycol methyl ether acetate (PGMEA) (11.23 g) were added into a reaction bottle and mixed, and the reaction bottle was heated to 50° C. Next, the first solution was added into the reaction bottle at 50° C. After the first solution was completely added and reacted for 3 hours, the reaction bottle was heated to 80° C., and the second solution was added into the reaction bottle. After the second solution was completely added and reacted for 10 hours, the reaction bottle was cooled down to 65° C., and the third solution was added into the reaction bottle. After reacting for 5 hours, the reaction bottle was cooled down to room temperature, and the result was concentrated and purified to obtain Compound (I), having an acid value of 79 mgKOH/g and a weight-average molecular weight of about 1450 g/mol. In the above reaction, the molar ratio of isophorone diisocyanate, polypropylene glycol (PPG-400), 2,2-bis(hydroxymethyl)propionic acid, and methacryloyloxyethyl isocyanate was about 2:1:2:2. The synthesis pathway of the above reaction was as follows:

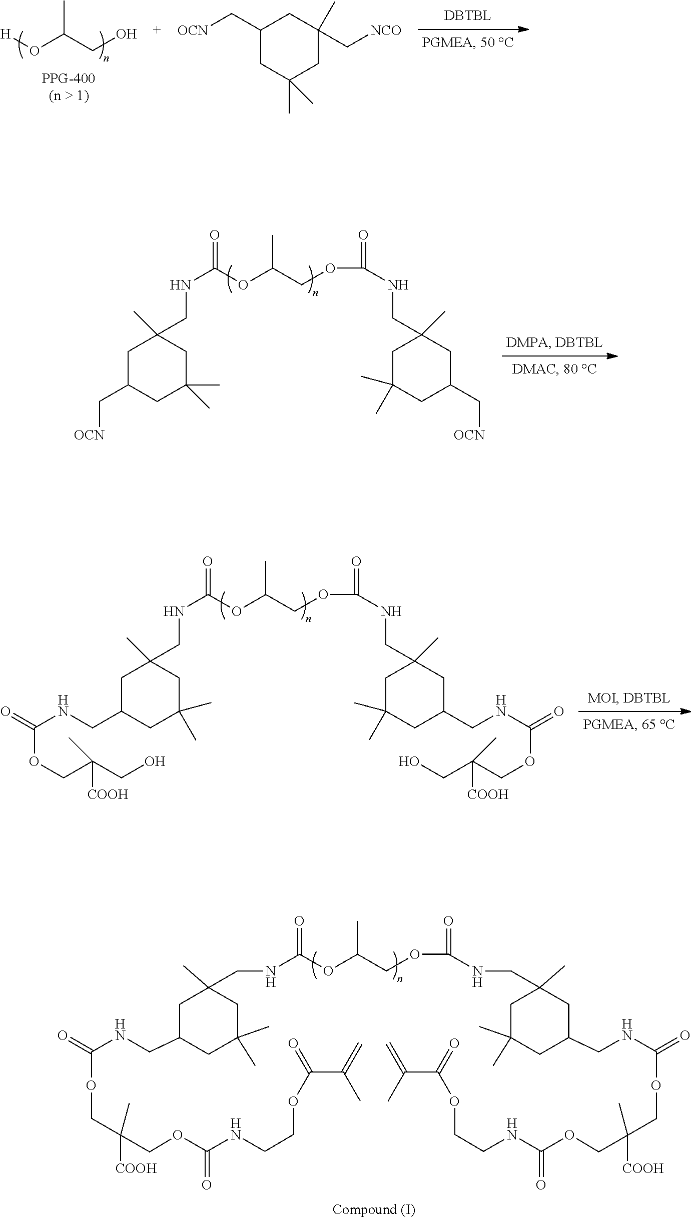

### Preparation Example 2

Polypropylene glycol (PPG-1000) (24.64 g) and dibutyltin dilaurate (DBTBL) (0.05 g) were dissolved in propylene glycol methyl ether acetate (PGMEA) (12 g) to obtain a first solution. 2,2-bis(hydroxymethyl)propionic acid (DMPA) (6.61 g) and dibutyltin dilaurate (DBTBL) (0.05 g) were dissolved in N,N-dimethylacetamide (DMAc) (13.22 g) to obtain a second solution. Methacryloyloxyethyl isocyanate (MOI) (7.65 g) and dibutyltin dilaurate (DBTBL) (0.05 g) were dissolved in propylene glycol methyl ether acetate (PGMEA) (12 g) to obtain a third solution.

Isophorone diisocyanate (IPDI) (10.95 g) and propylene glycol methyl ether acetate (PGMEA) (12.79 g) were added into a reaction bottle and mixed, and the reaction bottle was heated to 50° C. Next, the first solution was added into the reaction bottle at 50° C. After the first solution was completely added and reacted for 3 hours, the reaction bottle was heated to 80° C., and the second solution was added into the reaction bottle. After the second solution was completely added and reacted for 10 hours, the reaction bottle was cooled down to 65° C., and the third solution was added into the reaction bottle. After reacting for 5 hours, the reaction bottle was cooled down to room temperature, and the result was concentrated and purified to obtain Compound (II), having an acid value of 55 mgKOH/g and a weight-average molecular weight of about 2078 g/mol. In the above reaction, the molar ratio of isophorone diisocyanate, polypropylene glycol (PPG-1000), 2,2-bis(hydroxymethyl)propionic acid, and methacryloyloxyethyl isocyanate was about 2:1:2:2.

### Preparation Example 3

Polypropylene glycol (PPG-2000) (33.02 g) and dibutyltin dilaurate (DBTBL) (0.033 g) were dissolved in propylene glycol methyl ether acetate (PGMEA) (13.71 g) to obtain a first solution. 2,2-bis(hydroxymethyl)propionic acid (DMPA) (4.43 g) and dibutyltin dilaurate (DBTBL) (0.033 g) were dissolved in N,N-dimethylacetamide (DMAc) (8.86 g) to obtain a second solution. Methacryloyloxyethyl isocyanate (MOI) (5.12 g) and dibutyltin dilaurate (DBTBL) (0.033 g) were dissolved in propylene glycol methyl ether acetate (PGMEA) (13.71 g) to obtain a third solution.

Isophorone diisocyanate (IPDI) (7.34 g) and propylene glycol methyl ether acetate (PGMEA) (13.71 g) were added into a reaction bottle and mixed, and the reaction bottle was heated to 50° C. Next, the first solution was added into the reaction bottle at 50° C. After the first solution was completely added and reacted for 3 hours, the reaction bottle was heated to 80° C., and the second solution was added into the reaction bottle. After the second solution was completely added and reacted for 10 hours, the reaction bottle was cooled down to 65° C., and the third solution was added into the reaction bottle. After reacting for 5 hours, the reaction bottle was cooled down to room temperature, and the result was concentrated and purified to obtain Compound (III), having an acid value of 37 mgKOH/g and a weight-average molecular weight of about 3086 g/mol. In the above reaction, the molar ratio of isophorone diisocyanate, polypropylene glycol (PPG-2000), 2,2-bis(hydroxymethyl)propionic acid, and methacryloyloxyethyl isocyanate was about 2:1:2:2.

### Preparation Example 4

Polyethylene glycol (PEG-2000) (33.02 g) and dibutyltin dilaurate (DBTBL) (0.033 g) were dissolved in propylene glycol methyl ether acetate (PGMEA) (13.71 g) to obtain a first solution. 2,2-bis(hydroxymethyl)propionic acid (DMPA) (4.43 g) and dibutyltin dilaurate (DBTBL) (0.033 g) were dissolved in N,N-dimethylacetamide (DMAc) (8.86 g) to obtain a second solution. Methacryloyloxyethyl isocyanate (MOI) (5.12 g) and dibutyltin dilaurate (DBTBL) (0.033 g) were dissolved in propylene glycol methyl ether acetate (PGMEA) (13.71 g) to obtain a third solution.

Isophorone diisocyanate (IPDI) (7.34 g) and propylene glycol methyl ether acetate (PGMEA) (13.71 g) were added into a reaction bottle and mixed, and the reaction bottle was heated to 50° C. Next, the first solution was added into the reaction bottle at 50° C. After the first solution was completely added and reacted for 3 hours, the reaction bottle was heated to 80° C., and the second solution was added into the reaction bottle. After the second solution was completely added and reacted for 10 hours, the reaction bottle was cooled down to 65° C., and the third solution was added into the reaction bottle. After reacting for 5 hours, the reaction bottle was cooled down to room temperature, and the result was concentrated and purified to obtain compound (IV), having an acid value of 37 mgKOH/g and a weight-average molecular weight of about 3075 g/mol. In the above reaction, the molar ratio of isophorone diisocyanate, polyethylene glycol (PEG-2000), 2,2-bis(hydroxymethyl)propionic acid, and methacryloyloxyethyl isocyanate was about 2:1:2:2.

### Coating Composition

### Example 1

A pigment (with a trade number of L0086, commercially available from BASF), a dispersant (with a trade number of BYK-163), and propylene glycol methyl ether acetate (PGMEA) as a solvent were mixed, wherein the weight ratio of the pigment, the dispersant, and the solvent was 1:1:8. Next, the mixture was combined with zirconium beads (with a size of 2 mm) in an amount of twice the weight of the mixture and subjected to grinding and dispersion treatment using a Red Devil paint shaker (model 1400-OH, manufactured by Red Devil, Inc.). After processing for two hours and removing the zirconium beads, Dispersion (1) was obtained.

Compound (III) obtained from Preparation Example 3 (100 parts by weight), an aliphatic urethane diacrylate (with a trade number of GU3010Z, manufactured by Gung-Jing Chemical) (100 parts by weight), diphenyl(2,4,6-trimethylbenzoyl)phosphine oxide (with a trade number of TPO, manufactured by BASF) (30 parts by weight), isopropylthioxanthone (ITX) (10 parts by weight), and Dispersion (1) (180 parts by weight) were added to a solvent (propylene glycol methyl ether acetate, PGMEA), and uniformly stirred at room temperature for 30 minutes under light-shielded conditions, obtaining Coating Composition (1), wherein the solid content of Coating Composition (1) was about 20-25%.

### Example 2

Example 2 was performed in the same manner as Example 1, except that the amount of the aliphatic urethane diacrylate (with a trade number of GU3010Z) was reduced from 100 parts by weight to 50 parts by weight, obtaining Coating Composition (2)

### Example 3

Example 3 was performed in the same manner as Example 1, except that 100 parts by weight of GU3010Z was replaced with 33.3 parts by weight of an aliphatic urethane diacrylate (with a trade number of GU3315Z, manufactured by Gung-Jing Chemical), the amount of diphenyl(2,4,6-trimethylbenzoyl)phosphine oxide was reduced from 30 parts by weight to 20 parts by weight, the amount of isopropylthioxanthone was reduced from 10 parts by weight to 6.67 parts by weight, and the amount of Dispersion (1) was reduced from 180 parts by weight to 133.32 parts by weight, obtaining Coating Composition (3).

### Example 4

Example 4 was performed in the same manner as Example 1, except that 100 parts by weight of GU3010Z was replaced with 25 parts by weight of GU3315Z, the amount of diphenyl(2,4,6-trimethylbenzoyl)phosphine oxide was reduced from 30 parts by weight to 18.75 parts by weight, the amount of isopropylthioxanthone was reduced from 10 parts by weight to 6.25 parts by weight, and the amount of Dispersion (1) was reduced from 180 parts by weight to 175 parts by weight, obtaining Coating Composition (4).

### Example 5

Compound (I) obtained from Preparation Example 1 (100 parts by weight), an aliphatic urethane diacrylate (with a trade number of GU3010Z, manufactured by Gung-Jing Chemical) (100 parts by weight), diphenyl(2,4,6-trimethylbenzoyl)phosphine oxide (with a trade number of TPO, manufactured by BASF) (75 parts by weight), isopropylthioxanthone (ITX) (30 parts by weight), and Dispersion (1) (300.3 parts by weight) were added to a solvent (propylene glycol methyl ether acetate, PGMEA), and uniformly stirred at room temperature for 30 minutes under light-shielded conditions, obtaining Coating Composition (5), wherein the solid content of Coating Composition (5) was about 20-25%.

### Example 6

Compound (II) obtained from Preparation Example 2 (100 parts by weight), an aliphatic urethane diacrylate (with a trade number of GU3010Z, manufactured by Gung-Jing Chemical) (50 parts by weight), an aliphatic urethane diacrylate (with a trade number of GU3315Z, manufactured by Gung-Jing Chemical) (50 parts by weight), diphenyl(2,4,6-trimethylbenzoyl)phosphine oxide (with a trade number of TPO, manufactured by BASF) (60 parts by weight), isopropylthioxanthone (ITX) (30 parts by weight), and Dispersion (1) (300.3 parts by weight) were added to a solvent (propylene glycol methyl ether acetate, PGMEA), and uniformly stirred at room temperature for 30 minutes under light-shielded conditions, obtaining Coating Composition (6), wherein the solid content of Coating Composition (6) was about 20-25%.

### Example 7

Compound (IV) obtained from Preparation Example 4 (100 parts by weight), an aliphatic urethane diacrylate (with a trade number of GU3315Z, manufactured by Gung-Jing Chemical) (100 parts by weight), diphenyl(2,4,6-trimethylbenzoyl)phosphine oxide (with a trade number of TPO, manufactured by BASF) (30 parts by weight), isopropylthioxanthone (ITX) (10 parts by weight), and Dispersion (1) (200 parts by weight) were added to a solvent (propylene glycol methyl ether acetate, PGMEA), and uniformly stirred at room temperature for 30 minutes under light-shielded conditions, obtaining Coating Composition (7), wherein the solid content of Coating Composition (7) was about 20-25%.

### Example 8

Compound (I) obtained from Preparation Example 1 (100 parts by weight), an aliphatic urethane diacrylate (with a trade number of GU3315Z, manufactured by Gung-Jing Chemical) (12.5 parts by weight), diphenyl(2,4,6-trimethylbenzoyl)phosphine oxide (with a trade number of TPO, manufactured by BASF) (28.12 parts by weight), isopropylthioxanthone (ITX) (11.25 parts by weight), and Dispersion (1) (112.5 parts by weight) were added to a solvent (propylene glycol methyl ether acetate, PGMEA), and uniformly stirred at room temperature for 30 minutes under light-shielded conditions, obtaining Coating Composition (8), wherein the solid content of Coating Composition (8) was about 20-25%.

### Example 9

Compound (III) obtained from Preparation Example 3 (100 parts by weight), dipentaerythritol hexaacrylate (DPHA) (12.5 parts by weight), diphenyl(2,4,6-trimethylbenzoyl)phosphine oxide (with a trade number of TPO, manufactured by BASF) (36 parts by weight), isopropylthioxanthone (ITX) (10 parts by weight), and Dispersion (1) (200 parts by weight) were added to a solvent (propylene glycol methyl ether acetate, PGMEA), and uniformly stirred at room temperature for 30 minutes under light-shielded conditions, obtaining Coating Composition (9), wherein the solid content of Coating Composition (9) was about 20-25%.

### Comparative Example 1

Compound (III) obtained from Preparation Example 3 (100 parts by weight), an aliphatic urethane diacrylate (with a trade number of GU3315Z, manufactured by Gung-Jing Chemical) (250 parts by weight), diphenyl(2,4,6-trimethylbenzoyl)phosphine oxide (with a trade number of TPO, manufactured by BASF) (35 parts by weight), isopropylthioxanthone (ITX) (17.5 parts by weight), and Dispersion (1) (175 parts by weight) were added to a solvent (propylene glycol methyl ether acetate, PGMEA), and uniformly stirred at room temperature for 30 minutes under light-shielded conditions, obtaining Coating Composition (10), wherein the solid content of Coating Composition (10) was about 20-25%.

### Comparative Example 2

A carboxyl-containing acrylic resin mixture (100 parts by weight), prepared from methacrylic acid (MAA), benzyl methacrylate (BzMA), methyl methacrylate (MMA), and 2-hydroxyethyl methacrylate (2-HEMA) with a molar ratio of MAA/BzMA/MMA/2-HEMA=25:14:75:16, an aliphatic urethane diacrylate (with a trade number of GU3010Z, manufactured by Gung-Jing Chemical) (100 parts by weight), diphenyl(2,4,6-trimethylbenzoyl)phosphine oxide (with a trade number of TPO, manufactured by BASF) (36 parts by weight), isopropylthioxanthone (ITX) (10 parts by weight), and dispersion (1) (200 parts by weight) were added to a solvent (propylene glycol methyl ether acetate, PGMEA), and uniformly stirred at room temperature for 30 minutes under light-shielded conditions, obtaining Coating Composition (11), wherein the solid content of Coating Composition (11) was about 20-25%.

### Comparative Example 3

Aliphatic urethane diacrylate (with a trade number of GU3010Z, manufactured by Gung-Jing Chemical) (100 parts by weight), fluorenyl-based hydroxyl-containing diacrylate (with a structure of

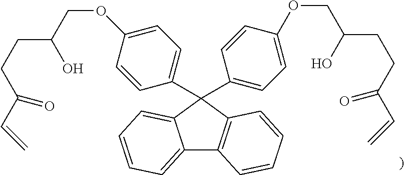 [SMILES: C=CC(=O)CCC(O)COc1ccc(C2(c3ccc(OCC(O)CCC(=O)C=C)cc3)c3ccccc3-c3ccccc32)cc1]

(with a trade number of F9PGA, SMS Technology Co., Ltd) (100 parts by weight), diphenyl(2,4,6-trimethylbenzoyl)phosphine oxide (with a trade number of TPO, manufactured by BASF) (50 parts by weight), isopropylthioxanthone (ITX) (20 parts by weight), and Dispersion (1) (200 parts by weight) were added to a solvent (propylene glycol methyl ether acetate, PGMEA) and uniformly stirred at room temperature for 30 minutes under light-shielded conditions, obtaining Coating Composition (12), wherein the solid content of Coating Composition (12) was about 20-25%.

### Comparative Example 4

A black carbon black pigment paste (with a trade number of BK-0712, commercially available from Lixin Chemical), a dispersant (with a trade number of BYK-163), and propylene glycol methyl ether acetate (PGMEA) as a solvent were mixed, wherein the weight ratio of pigment, dispersant, and solvent was 1:1:8. Next, the mixture was added to zirconium beads (with a size of 2 mm) at twice the weight of the mixture and subjected to grinding and dispersion using a Red Devil paint shaker (model 1400-OH, manufactured by Red Devil, Inc.). After 2 hours of treatment and removal of the zirconium beads, Dispersion (2) was obtained.

Phenolic acrylic resin (with a trade number of EA-7140, manufactured by Shin-Nakamura Chemical Industry) (100 parts by weight), dipentaerythritol hexaacrylate (DPHA) (100 parts by weight), diphenyl(2,4,6-trimethylbenzoyl)phosphine oxide (TPO, manufactured by BASF) (36 parts by weight), isopropylthioxanthone (ITX) (10 parts by weight), and Dispersion (2) (200 parts by weight) were added to a solvent (propylene glycol methyl ether acetate, PGMEA) and uniformly stirred at room temperature for 30 minutes under light-shielded conditions, obtaining Coating Composition (13), wherein the solid content of Coating Composition (13) was about 20-25%.

### Film Properties Evaluation

Coating compositions (1)-(13), obtained from Examples 1-9 and Comparative Examples 1-4, were applied onto glass and polyimide (PI) substrates by spin coating to form coatings, and then baked at 100° C. for 2 minutes to obtain films with a controlled thickness of about 2.0±0.2 μm. Next, the films were exposed using digital lithography technology (DLT) (wavelength: 403 nm, exposure dose: 800 mJ/cm²). Development was carried out with a 2.38 wt % aqueous solution of tetramethylammonium hydroxide (TMAH) for 60 seconds, followed by rinsing with PGMEA for 30 seconds. The films were then baked at 160° C. to obtain Patterned Films (1)-(13), with Patterned Films (1)-(9) prepared from Coating Compositions (1)-(9) of Examples 1-9, and Patterned Films (10)-(13) prepared from Coating Composition (10)-(13) of Comparative Examples 1-4, respectively.

Next, the Patterned Films (1)-(7) were evaluated for patterning resolution, adhesion, infrared (IR) light transmittance, optical density (OD), and flexibility. Patterning resolution was evaluated by determining whether a coating composition could form patterned films with line widths less than or equal to 30 μm. Films that formed patterns were recorded as “pass,” and those that did not were recorded as “fail.” Adhesion was evaluated using the cross-hatch test according to ASTM D3359. Adhesion greater than 4B was recorded as “pass,” otherwise “fail.” IR Transmittance was evaluated by measuring the transmittance of the films at a wavelength of 900 nm. Transmittance greater than or equal to 80% was recorded as “pass,” otherwise “fail.” Optical Density (OD) was measured using an optical density meter. OD greater than or equal to 2 was recorded as “pass,” otherwise “fail.” Flexibility evaluation was to cut films (with the PI substrate) into test pieces (10 mm×100 mm) and bend them at the center with a curvature radius of 1.0 mm (bending angle 180°, load of 1 kg, bending 3 times). Films without cracks were recorded as “pass,” whereas films with cracks, damage, or delamination were recorded as “fail.” The evaluation results showed that Patterned Films (1)-(7) passed all evaluations.

Patterned film (8) was evaluated for adhesion, IR transmittance, optical density, and flexibility, and passed all evaluations. Patterned film (9) was evaluated for patterning resolution, IR transmittance, and optical density, and passed all evaluations. Patterned film (10) was evaluated for patterning resolution, adhesion, optical density, and flexibility, and failed all evaluations. Patterned Films (11)-(13) were evaluated for flexibility and failed.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A compound, which has a structure of Formula (I) 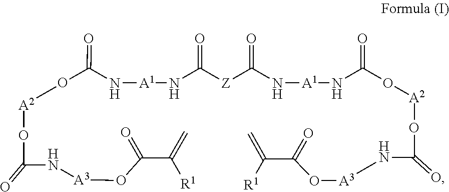
wherein Z is 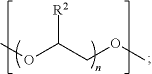
A¹ is independently C3-C12 alkylene group, 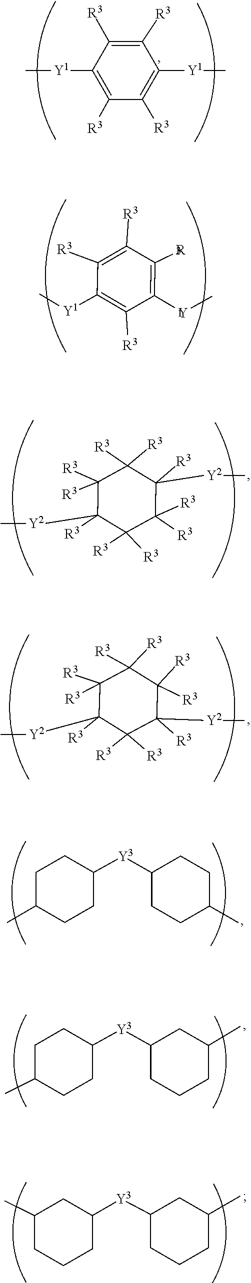
A² is independently C2-C12 alkylene group having at least one carboxyl group; A³ is independently C1-C12 alkylene group, C2-C12 divalent ether group, C4-C8 cycloalkylene group, phenylene, or 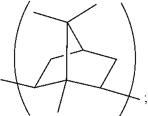
R¹ and R² are independently hydrogen or methyl; n is an integer from 6 to 100; R³ is independently hydrogen or C1-C6 alkyl group Y¹ is independently C1-C6 alkylene group; Y² is independently a single bond, or C1-C6 alkylene group; Y³ is —O—, 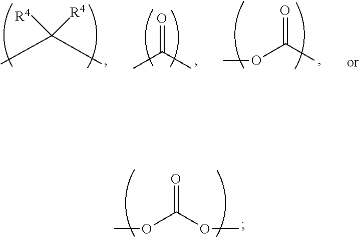
and, R⁴ is independently hydrogen, fluorine, methyl, or fluoromethyl.

2. The compound as claimed in claim 1, wherein A¹ is independently

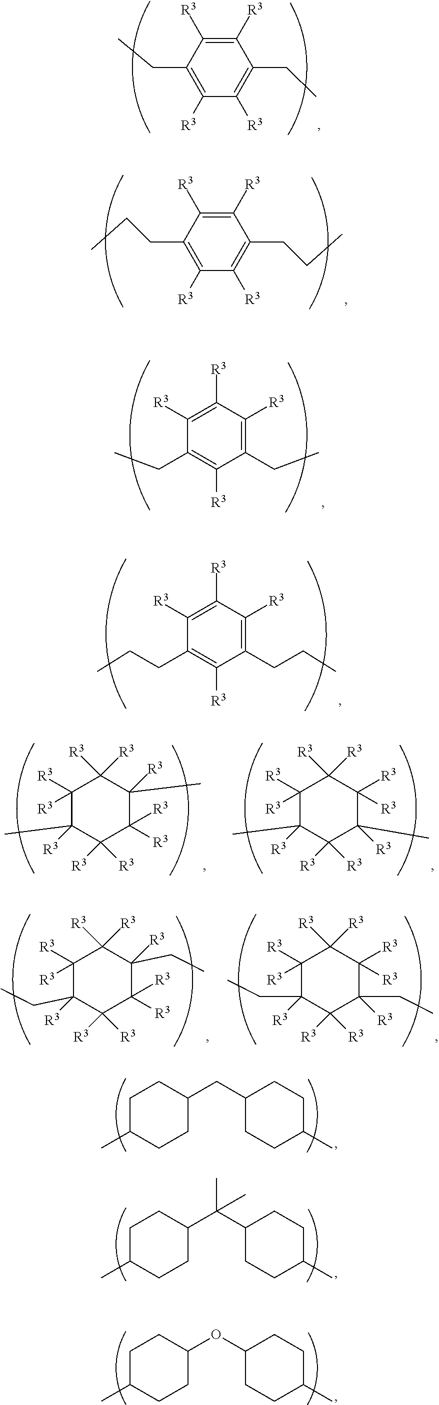

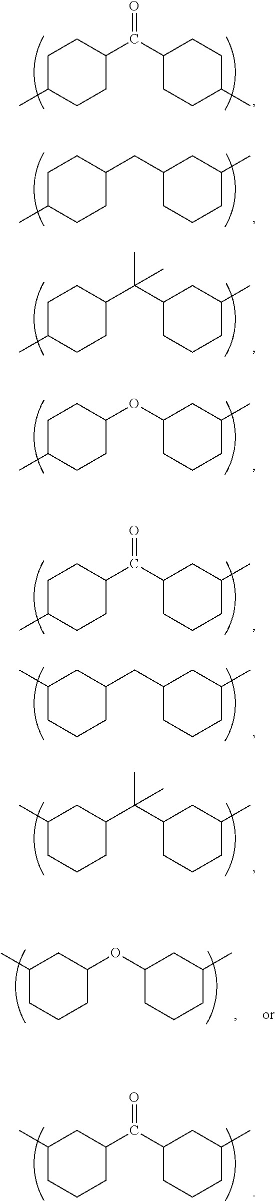

3. The compound as claimed in claim 1, wherein the compound is 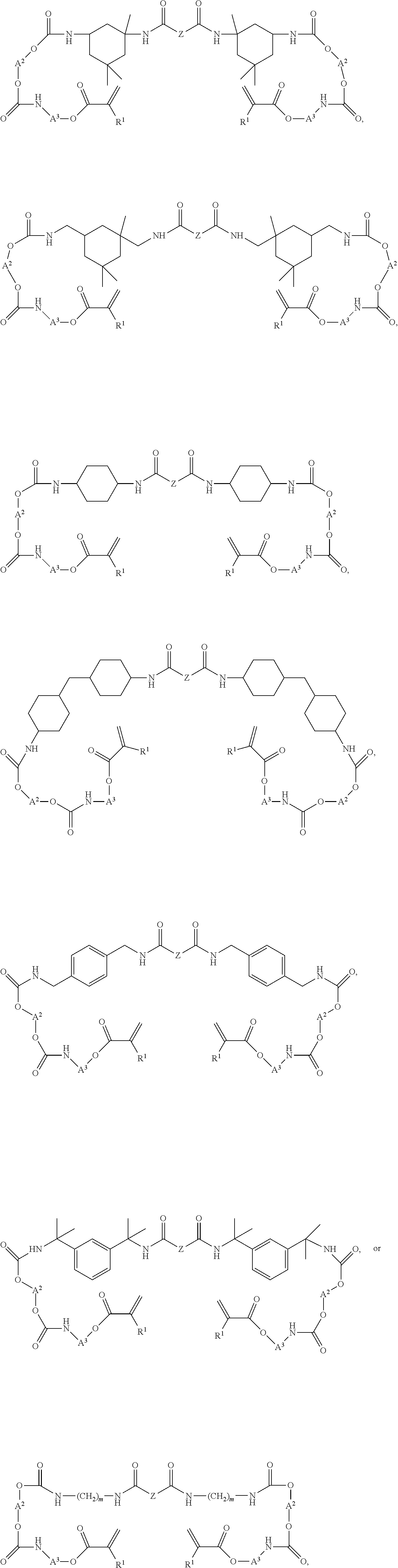
wherein Z is 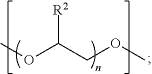
A² is independently C2-C12 alkylene group having at least one carboxyl group; A³ is independently C1-C12 alkylene group, C2-C12 divalent ether group, C4-C8 cycloalkylene group, phenylene, or 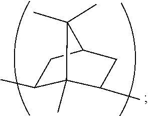
R¹ and R² are independently hydrogen or methyl; n is an integer from 6 to 100; and, m is an integer from 3 to 12.

4. The compound as claimed in claim 1, wherein the compound is 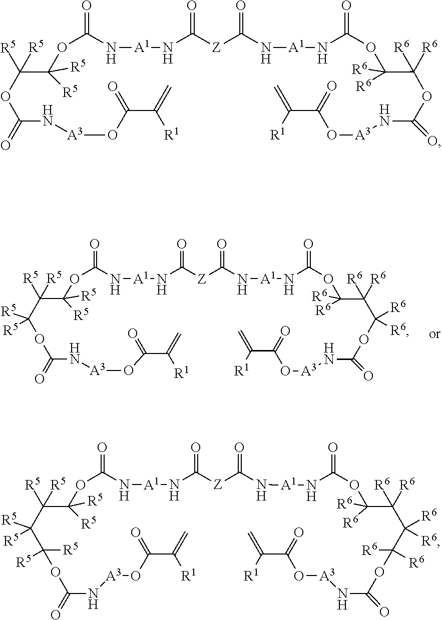
wherein Z is 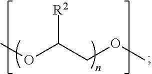
A¹ is independently C3-C12 alkylene group, 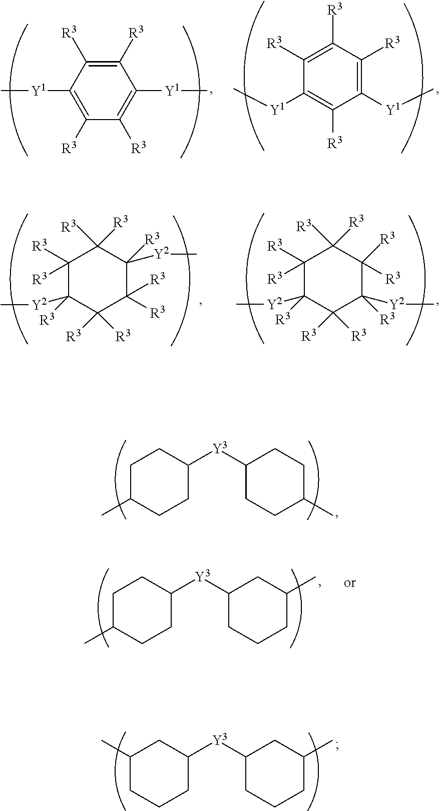
A³ is independently C1-C12 alkylene group, C2-C12 divalent ether group, C4-C8 cycloalkylene group, phenylene, or 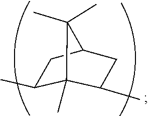
R¹ and R² are independently hydrogen or methyl; n is an integer from 6 to 100; R³ is independently hydrogen, or C1-C6 alkyl group Y¹ is independently C1-C6 alkylene group; Y² is independently a single bond, or C1-C6 alkylene group; Y³ is —O—, 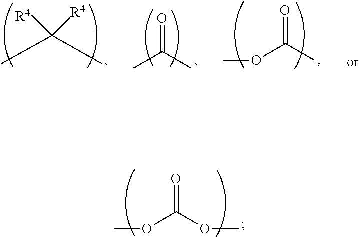
R⁴ is independently hydrogen, fluorine, methyl or fluoromethyl; R⁵ is independently hydrogen, C1-C3alkyl group, or —COOH, and wherein at least one of R⁵ is —COOH; and, R⁶ is independently hydrogen, C1-C3alkyl group, or —COOH, and wherein at least one of R⁶ is —COOH.

5. The compound as claimed in claim 1, wherein the compound is 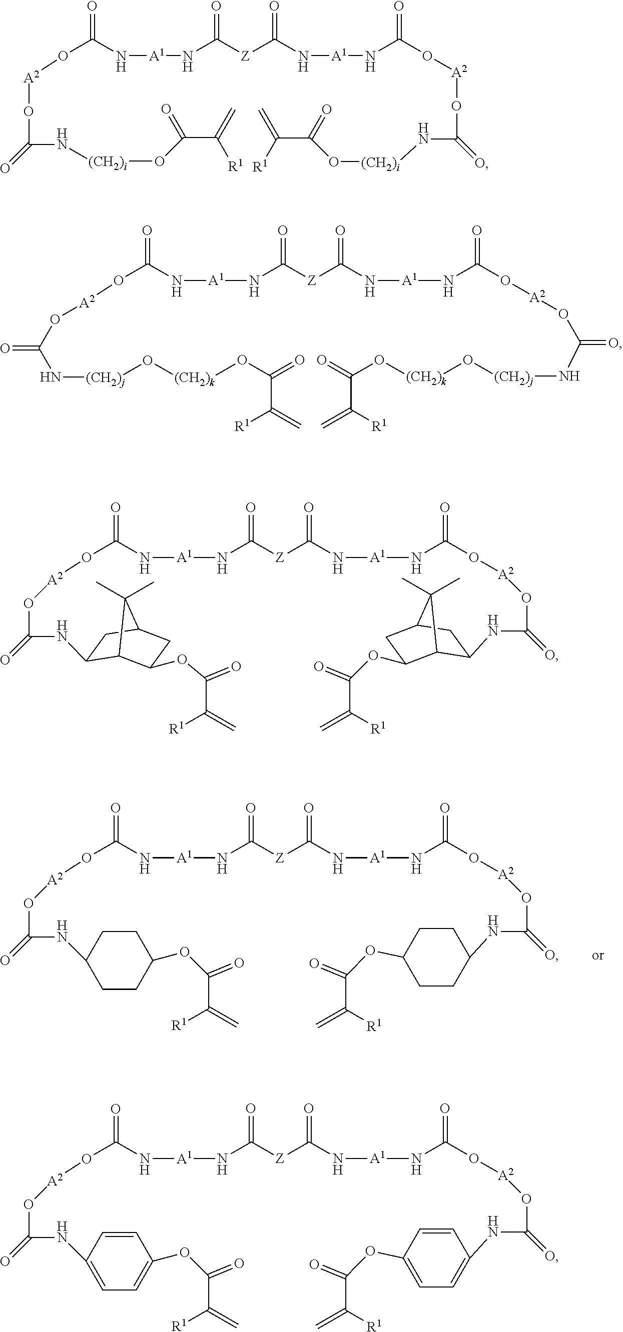
wherein Z is 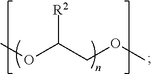
A¹ is independently C3-C12 alkylene group, 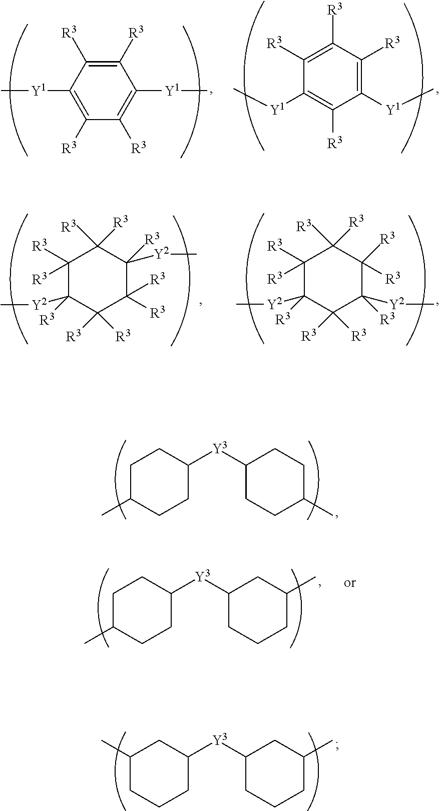
A² is independently C2-C12 alkylene group having at least one carboxyl group; R¹ and R² are independently hydrogen or methyl; n is an integer from 6 to 100; R³ is independently hydrogen, or C1-C6 alkyl group Y¹ is independently C1-C6 alkylene group; Y² is independently a single bond, or C1-C6 alkylene group; Y³ is —O—, 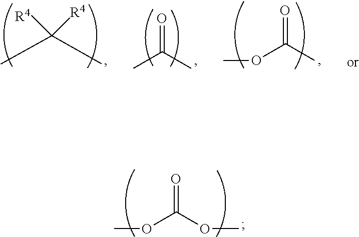
R⁴ is independently hydrogen, fluorine, methyl or fluoromethyl; i is an integer from 1 to 12; and j and k are independently an integer from 1 to 11, wherein a sum of j and k is 2 to 12.

6. The compound as claimed in claim 1, wherein the compound has an acid value of 20 mgKOH/g to 100 mgKOH/g.

7. A coating composition, comprising:
100 parts by weight of component (A), wherein component (A) is the compound as claimed in claim 1; and
1 to 200 parts by weight of component (B), wherein component (B) is a compound having at least two reactive functional groups, and each reactive functional group is acrylate group, or methacrylate group.

8. The coating composition as claimed in claim 7, wherein component (B) is a compound having two acrylate groups, a compound having two methacrylate groups, a compound having three acrylate groups, a compound having three methacrylate groups, a compound having four acrylate groups, a compound having four methacrylate groups, a compound having five acrylate groups, a compound having five methacrylate groups, a compound having six acrylate groups, a compound having six methacrylate groups, or a combination thereof.

9. The coating composition as claimed in claim 7, wherein component (B) is 1,6-hexanediol diacrylate, 1,6-hexanediol dimethacrylate, 1,9-bis(acryloyloxy)nonane, 1,9-bis(methacryloyloxy)nonane, 1,10-decanediol diacrylate, 1,10-decanediol dimethacrylate, neopentyl glycol diacrylate, neopentyl glycol dimethacrylate, polyethylene glycol (200) diacrylate, polyethylene glycol (400) diacrylate, polyethylene glycol (600) diacrylate, dipropylene glycol diacrylate, dipropylene glycol dimethacrylate, tripropylene glycol diacrylate, tripropylene glycol dimethacrylate, di(ethylene glycol) diacrylate, di(ethylene glycol) dimethacrylate, triethylene glycol diacrylate, triethylene glycol dimethacrylate, tetraethylene glycol diacrylate, tetraethylene glycol dimethacrylate, dipentaerythritol hexaacrylate, dipentaerythritol hexamethacrylate, dipentaerythritol pentaacrylate, dipentaerythritol pentamethacrylate, polypropylene glycol diacrylate, poly(tetramethylene ether glycol) diacrylate, poly(ethylene-propylene glycol) diacrylate, tricyclodecanedimethanol diacrylate, trimethylolpropane triacrylate, pentaerythritol triacrylate, pentaerythritol tetraacrylate, di(trimethylolpropane) tetraacrylate, di(polypentaerythritol) polyacrylate, polypentaerythritol polyacrylate, polybutadiene diacrylate, 3-methyl-1,5-pentanediol diacrylate, ethoxylated (3) bisphenol A diacrylate, tris(2-hydroxyethyl)isocyanurate triacrylate, ethoxylated (20) trimethylolpropane triacrylate, ethoxylated (3) trimethylolpropane triacrylate, propoxylated (3) trimethylolpropane triacrylate, ethoxylated pentaerythritol tetraacrylate, ethoxylated (6) trimethylolpropane triacrylate, ethoxylated (9) trimethylolpropane triacrylate, ethoxylated (4) bisphenol A diacrylate, ethoxylated (10) bisphenol A diacrylate, esterdiol diacrylate, alkoxylated diacrylate, propoxylated (2) neopentyl glycol diacrylate, propoxylated (3) glyceryl triacrylate, ethoxylated (15) trimethylolpropane triacrylate, ethoxylated (12) glyceryl triacrylate, 2-(dimethylamino)ethyl acrylate, 3-(dimethylamino)propyl acrylate, 2-(diethylamino)ethyl acrylate, 3-(diethylamino)propyl acrylate, 2-(dimethylamino)ethyl methacrylate, 3-(dimethylamino)propyl methacrylate, 2-(diethylamino)ethyl methacrylate, 3-(diethylamino)propyl methacrylate, urethane multi-acrylate, urethane multi-methacrylate, or a combination thereof.

10. The coating composition as claimed in claim 7, further comprising:
component (C), wherein component (C) is an initiator, and a weight ratio of component (C) to a total weight of components (A) and (B) is from 1:20 to 1:2.

11. The coating composition as claimed in claim 10, wherein component (C) is a photoinitiator.

12. The coating composition as claimed in claim 10, wherein component (C) is a benzoin-based compound, an acetophenone-based compound, a thioxanthone-based compound, a ketal compound, a benzophenone-based compound, an α-aminoacetophenone compound, an acylphosphine oxide compound, a biimidazole-based compound, a triazine-based compound, or a combination thereof.

13. The coating composition as claimed in claim 7, further comprising:
component (D), wherein component (D) is a solvent, and a weight ratio of component (D) to a total weight of components (A) and (B) is from 1:2 to 5:1.

14. The coating composition as claimed in claim 13, wherein component (D) is an aromatic hydrocarbon solvent, an alcohol solvent, an ether solvent, a ketone solvent, an ester solvent, a nitrogen-containing solvent, or a combination thereof.

15. The coating composition as claimed in claim 13, wherein component (D) is benzene, toluene, xylene, ethylbenzene, diethylbenzene, trimethylbenzene, triethylbenzene, cyclohexane, cyclohexene, decahydronaphthalene, dipentene, pentane, hexane, heptane, octane, nonane, decane, ethylcyclohexane, methylcyclohexane, p-menthane, dipropyl ether, dibutyl ether, anisole, ethyl acetate, butyl acetate, pentyl acetate, methyl isobutyl ketone, cyclohexylbenzene, cyclohexanone, cyclopentanone, triglyme, 1,3-dimethyl-2-imidazolidinone, N-methyl-2-pyrrolidone, methyl ethyl ketone, N,N-dimethylacetamide, N,N-dimethylpropionamide, γ-butyrolactone, N,N-dimethylformamide propylene glycol methyl ether acetate, dimethyl sulfoxide, or a combination thereof.

16. The coating composition as claimed in claim 7, further comprising:
component (E), wherein component (E) is a pigment, and a weight ratio of component (E) to a total weight of components (A) and (B) is from 1:100 to 20:100.

17. The coating composition as claimed in claim 7, wherein component (E) is azo pigment, thioindigo pigment, anthraquinone pigment, perylene pigment, pyrrole pigment, dioxazine pigment, phthalocyanine pigment, isoindolinone pigment, ceramic pigment, oxide pigment, metal pigment, alloy pigment, mica, nitride pigment, sulfide pigment, carbon black, or a combination thereof.

18. The coating composition as claimed in claim 7, further comprising:
component (F), wherein component (F) is a dispersant, and a weight ratio of component (F) to a total weight of components (A) and (B) is from 1:100 to 20:100.

19. A film, which comprises a cured product of the coating composition as claimed in claim 7.

20. The film as claimed in claim 19, wherein the film serves as an infrared-transmissive light-shielding layer for an organic light-emitting diode device, a mini/micro light-emitting diode device, or a semiconductor device.
